(19) United States
(12) Patent Application Publication
(10) Pub. No.: US 2007/0256096 A1
(43) Pub. Date: Nov. 1, 2007

(54) System and method for pushing conditional message data between a client device and a server device in an internet protocol television network

(75) Inventor: Albert Philip Wilhelm, Austin, TX (US)

Correspondence Address: G. Michael Roebuck, PC, FROST BANK BUILDING, 6750 WEST LOOP SOUTH, SUITE 920, BELLAIRE, TX, 77401, US

(73) Assignee: SBC Knowledge Ventures L.P., Reno, NV (US)

(21) Appl. No.: 11/415,061

(22) Filed: May 1, 2006

(51) Int. Cl. H04N 7/025; H04N 7/16; H04N 7/173; H04N 7/10

(52) U.S. Cl. 725/34; 725/112; 725/113; 725/110; 725/35; 725/25

(57) ABSTRACT

In one embodiment a method is disclosed for monitoring a multiplicity of set top boxes (STBs) in an internet protocol television (IPTV) network including receiving in an IPTV network server, conditional message data pushed from the multiplicity of set top boxes (STBs); analyzing in the IPTV server, the STB conditional message data to determine network status information data related to a set of STBs selected from the multiplicity of STBs; and pushing network status information data to the set of STBs. In another embodiment a system for monitoring an internet protocol television (IPTV) network is disclosed including an IPTV head-end server processor coupled to a memory in the IPTV server; a computer program embedded in the memory, the computer program including instructions to acquire conditional message data; and a computer program embedded in memory, the computer program including instructions to push the conditional message data to memory when the conditional message data exceeds a predetermined threshold.

### BACKGROUND OF THE DISCLOSURE

1. Field of the Disclosure

The disclosure relates to the field of internet protocol television (IPTV).

2. Description of the Related Art

Digital television systems in which a digital television signal is delivered to subscribing consumers using a broadband connection usually over a network. Digital television service may be provided in conjunction with Video on Demand (VOD) and may also include Internet services such as Web access and Voice over IP (VOIP) where it may be called “Triple Play.” Triple play may be supplied by a broadband operator using the same infrastructure for all three services.

Video data is usually received at a home or business using a set top box (STB). Subscribers select programming and receive content via the STB. Outages may be encountered at the STB or upstream in the network.

### BRIEF DESCRIPTION OF THE DRAWINGS

For detailed understanding of the illustrative embodiment, references should be made to the following detailed description of an illustrative embodiment, taken in conjunction with the accompanying drawings, in which like elements have been given like numerals.

FIG. 1 is a schematic diagram depicting an illustrative embodiment showing a set top box (box) and head end server in an internet protocol television (IPTV) system;

FIG. 2 is an illustrative embodiment of a process flow of error log or status information from an STB to a Head-End or other information storage and analysis facility;

FIG. 3 is an illustrative embodiment of a process flow of error log or status information from an STB to a Head-End or other information storage and analysis facility;

FIG. 4 is an illustrative embodiment of a process flow of error log or status information related to an STB;

FIG. 5 is an illustrative embodiment of a process flow of error log or status information from Head-End or other information storage and analysis facility to an STB;

FIG. 6 is an illustrative embodiment of a process flow of error log or status information from Head-End or other information storage and analysis facility to an STB;

FIG. 7 is an illustrative embodiment of a process flow of error log or status information related to a head-end facility;

FIG. 8 is a flow chart of functions performed in a illustrative embodiment; and

FIG. 9 is a diagrammatic representation of a machine in the form of a computer system within which a set of instructions, when executed, may cause the machine to perform any one or more of the methodologies of the illustrative embodiment.

### DETAILED DESCRIPTION OF AN ILLUSTRATIVE EMBODIMENT

In view of the above, an illustrative embodiment is presented through one or more of its various aspects to provide one or more advantages, such as those noted below.

In a particular embodiment a method for monitoring a plurality of client devices, such as, set top boxes (STBs) in a server device, such as an internet protocol television (IPTV) network is disclosed. The method includes receiving in an IPTV network server conditional message data pushed from a plurality of set top boxes (STBs), analyzing in the IPTV server, the STB conditional message data to determine network status information data related to a set of STBs selected from the plurality of STBs, and pushing network status information data to the set of STBs.

In another particular embodiment the method further includes receiving a pulse from at least one of the plurality of STBs, determining that the pulse has stopped for the at least one of the plurality of STBs, and analyzing conditional message data for the at least one of the plurality of STBs for which the pulse has stopped.

In another particular embodiment the set of STBs is one selected from the group consisting of a geographic group, targeted advertising group, and network node related group.

In another particular embodiment the method further includes removing STBs from a targeted advertising campaign hit list of STBs based on the conditional message data.

In another particular embodiment the pushed conditional message data from at least one of the plurality of STBs is received in the IPTV network server upon the occurrence of an indicator datum in the conditional message data exceeding a predetermined threshold and detecting a power interruption to at least one of the plurality of STBs.

In another particular embodiment the method further includes wherein the conditional message data is selected from the group consisting of signal reliability parameter data, quality of service indication parameter data, component status parameter data, and processor status parameter data.

In another particular embodiment the method further includes characterizing the set of STBs according to at least one of the group consisting of subscriber activity data, signal strength over time data, and signal strength associated with delivered content data.

In a particular embodiment a method for monitoring an internet protocol television (IPTV) network data from an IPTV head end network server is disclosed. The method includes pushing, to an IPTV network server database, conditional message data in a conditional message; determining an IPTV network status when a parameter of the conditional message data exceeds a predetermined threshold; and pushing conditional message data indicating IPTV network status information data to a set of STBs.

In another particular embodiment the set of STBs is selected from the group consisting of a geographic set, targeted advertising set, and network node related set.

In another particular embodiment the conditional message data is selected from the group consisting of signal reliability parameter data, quality of service indication parameter data, component status parameter data, and processor status parameter data.

In another particular embodiment the method further includes pushing conditional message data to the set of STBs when the IPTV network is determined to function below a predetermined threshold.

In a particular embodiment a set-top box (STB) in an IPTV network is disclosed. The STB includes a STB processor coupled to a memory; a computer program embedded in the memory, the computer program including instructions to push conditional message data to a log file when a conditional message indicator datum in the conditional message data exceeds a predetermined threshold; instructions to push the conditional message indicator datum to an IPTV network server; and an interface in data communication with the IPTV network server.

In another particular embodiment the STB the conditional message data is selected from the group consisting of signal reliability parameter data, quality of service parameter data, component status parameter data and processor status parameter data.

In another particular embodiment the memory is associated with a network server database that is selected from the group consisting of a subscriber activity log database, an STB component status database, and a video infrastructure element manager database.

In another particular embodiment the STB further includes a temporary power source that provides power to the STB when the STB loses power, wherein the temporary power source is selected from the group consisting of a capacitor and a battery.

In a particular embodiment a system for monitoring an internet protocol television (IPTV) network is disclosed. The head-end facility includes an IPTV head-end server processor coupled to a memory in the IPTV server; a computer program embedded in the memory, the computer program including instructions to acquire conditional message data, and instructions to push the conditional message data to memory when an indicator datum is in the conditional message data exceeds a predetermined threshold; and an interface in data communication with a network server database.

In another particular embodiment the system further includes a pulse interface in data communication with an intermediate server in an IPTV network.

In a particular embodiment a computer readable medium having a computer program for monitoring an internet protocol television (IPTV) network embedded therein is disclosed. The computer program includes instructions to receive in an IPTV network server conditional message data pushed from a plurality of set top boxes (STBs); instructions to analyze in the IPTV server, the STB conditional message data to determine network status information data related to a group of STBs selected from the plurality of STBs; and instructions to push network status information data to the plurality of STBs.

In another particular embodiment the medium further includes instructions to receive a pulse from at least one of the plurality of STBs; instructions to determine that the pulse has stopped for the at least one of the plurality of STBs; and instructions to analyze conditional message data for the at least one of the plurality of STBs for which the pulse has stopped.

In another particular embodiment the set of STBs is selected from the group consisting of a geographic set, targeted advertising set, and network node related set.

In another particular embodiment the medium further includes instructions to remove STBs from a targeted advertising campaign hit list of STBs based on the conditional message data.

In another particular embodiment the pushed conditional message data from at least one of the plurality of STBs is received in the IPTV network server upon the occurrence of an indicator datum in the conditional message data exceeding a predetermined threshold and detecting a power interruption to at least one of the plurality of STBs.

In another particular embodiment the conditional message data is selected from the group consisting of signal reliability parameter data, quality of service indication parameter data, component status parameter data, and processor status parameter data.

In another particular embodiment the method further includes characterizing the group of STBs according to at least one of the group consisting of subscriber activity data, signal strength over time data and signal strength associated with delivered content data.

In a particular embodiment a computer readable medium having a computer program for monitoring an internet protocol television (IPTV) network embedded therein is disclosed. The computer program includes instructions to push, to an IPTV network server database, conditional message data in a conditional message; instructions to determine an IPTV network status when an indicator datum in the conditional message data exceeds a predetermined threshold; and instructions to push conditional message data indicating IPTV network status information data to a set of STBs selected from the plurality of STBs.

In another particular embodiment the set of STBs is one selected from the group consisting of a geographic set, targeted advertising set, and network node related set.

In an illustrative embodiment a two-way pushed conditional data messaging capability is implemented between a client device, such as an STB and a server device, such as an IPTV network node, such as a Video Infrastructure Network Manager (VINM) resident on an IPTV server that may be associated with or contained in a head-end server. A head-end server is a master facility for receiving communication signals for processing and distribution over a communication system such as an IPTV network. For purposes of this disclosure a server or node includes but is not limited to a electronic data warehouse (EDW), data center, central office (CO), an intermediate office (10), video hub office or head end (VHO) and super hub office (SHO).

Conditional messages containing conditional message data are pushed (sent pro-actively) based on predefined conditions from an STB to a point on a Network and stored in a database. Pushed conditional messages are not requested by a recipient but are sent by an originator based on criteria or conditions defined as stored within the originating processor sending the conditional message. When an indicator datum in the conditional message data exceeds a predetermined threshold a conditional message is pushed. The database may be resident on a server associated with or contained in a head-end facility. The pushed conditional messages may be stored for access associated with a Video Infrastructure Network Manager (VINM). A VINM enables correlation and analysis of messages from many STBs in order to determine problems associated with network infrastructure elements or individual STBs.

Alternatively, conditional message data may be pushed from a point on an IPTV network, such as a SHO or head-end, or other hierarchically tiered network facility, such as a VHO, CO or IO to one or more “downstream” users' STBs. These messages may include an indicator datum or error code that informs customers of network services status, head-end facilities status and any operations that may affect customers' services.

Conditional message data including but not limited to error or status messages data or logs data from a user's STB, notifies network management via the SHO that a STB has gone down or may be having problems. Pushing the conditional message data to a network node memory such as a head-end database provides technical support to quickly analyze a problem. Technical support may then contact a customer as desired and/or interrogate the CPE to troubleshoot the problem proactively rather than waiting for a customer to call a support line to report an associated problem. Likewise, if any head-end equipment experiences a failure, the head-end may push conditional message data including an indicator datum to the STBs it serves informing downstream servers and STBs of the type of problem or failure, the approximate downtime anticipated until resolution, and a current status. When the network is up and running or about to come up, a conditional message may be pushed from the head-end to the STB of the event. These capabilities will result in fewer calls from customers to technical support facilities.

In one embodiment conditional messaging data includes an indicator datum or data including but not limited to a failure message data or error log data file is pushed from an STB to an IPTV Network server thereby alerting network management by writing to an error log database. The conditional message data sent may contain information that describes the state that the STB was in before or during the failure condition. The STB conditions or indicator datum/data that may be reported include but are not limited to STB hard drive is running low on memory, signal reliability degraded, quality of service degraded, and device related component error messages. This allows for rapid responses to STB hard drive crashes or STB software problems. For example, STB software downloads or uploads may be made rapidly, and may not even be noticed by consumers. If the consumer is notified, the notification may include information on how the system is going to be fixed and a predicted time schedule for service interruption and resumption of service. Hardware problems can be diagnosed without customer intervention and a service call scheduled before the customer is aware of the STB hardware problem.

In another embodiment an STB pushes conditional message data to memory to generate an error or status log continuously over time. For example, error and status log, device performance history data can be recorded periodically and in the event of a failure or near failure condition, the performance history information data would be pushed from the memory in a conditional message to a network node such as an intermediate server between the head end and the STB in a IPTV network. Additionally, a conditional message containing an indicator datum or status log of device performance data may be pushed from an STB to a network node at predetermined intervals. The indicator datum, status or error log data may contain parameters such as but not limited to signal integrity, number or rate of packet transfers, dB losses, or network utilization.

In the event that parameters within an STB indicate a pending failure condition may be imminent, a conditional message containing a status log may be pushed to a network node. For example, for a status log that is regularly updated, a predetermined time period of history data may be contained within the message or status log.

The conditional messages, containing conditional message data including but not limited to status or error logs that have been pushed from one or more STBs may be correlated by geographic areas and times. This allows network support personnel to be alerted to conditions that may be occurring. Examination and correlation of these proactive system status or error messages allows for determination of any commonality among them, and allows for more rapid responses based on whether any problems result from individual STB conditions or more widespread network system issues. Problems may be correlated to localities, and then a response may be more rapidly and effectively directed to those localities. Additionally, when a network system condition affecting customer service is encountered, messages may be pushed from Network nodes to downstream customer premise equipment (CPE) STBs. The messages may be pushed to selected customer groups being impacted by the system condition. System conditions may affect limited subsets of channels, services, customers or geographic areas.

When and whether to proactively push a conditional message data including status or error data depends on predetermined conditions such as monitoring parameter data or indicator datum for exceeding a threshold value that may be monitored or measured at an STB or a node including but not limited to the SHO. One type STB parameter to be observed and recorded is associated with signal reliability or quality of service between an STB and network node. This signal reliability and quality of service parameter can be affected by conditions in or near the STB. In some instances a similar parameter may be associated with whether the head-end is experiencing signal/DB losses. These losses may be due to network conditions. These losses could be sporadic at times and may be difficult to isolate as to whether the conditions are correlated over portions of the network system or to individual CPE. Proactively delivering data, by pushing conditional message data including but not limited to indicator datum/data such as status information in conditional messages to a network node where these data may be correlated facilitates more rapid problem analysis. For example if the STB is not able to communicate with the IPTV Head-end facility, an STB log file may be released to a Network node such as an intermediate server. Other parameters to monitor include conditions related to components of the STB. The status of these conditions may be continuously, periodically or conditionally pushed to a status or error log.

In one particular embodiment a processor may be interrogated (“pinged”) for status information by an STB resident software agent. If errors are occurring or a failure condition is indicated, then the STB can send a message and/or error log file. A processor may have its own agent performing queries, for example as part of a kernel in the processor. The query seeks to determine a processor status parameter datum. This may be an implementation such as a pulse signal originating from the processor indicating the processor is active (i.e., a “processor pulse”). When a processor stops or fails, the pulse stops and the processor sends the information to the STB, and the STB may push a conditional message including error log information data before experiencing a complete component shutdown. In another embodiment an intermediate server or head end senses a pulse or periodic pulse message from the STB. When the STB pulse stops, the head end or intermediate server analyzes the STB conditional message data previously sent and stored or sent concurrently from the STB at failure. The conditional message data includes but is not limited to prior conditional message data and performance history pushed to memory on the STB, intermediate server or head end. Conditional message data can originate and be pushed from an STB or an IPTV node.

In another aspect a log file of conditional message data including STB parameters is continuously pushed to memory medium. This conditional message containing log file data may reside in memory on the STB or may be located outside of the STB. This memory may be an STB ‘hard’ drive or random access memory (RAM) or may be pushed to an intermediate storage device, for example a server memory. The log file may include any of the conditional message data discussed herein. In one embodiment, a pulse can be sent from a head-end intermediate server or STB. The pulse can be initiated upon receiving a request from another monitoring software agent based on sensing a parameter indicating that a failure is imminent or a predetermine condition has been met. The monitoring software agent can be located in the head-end, STB or intermediate server and can monitor and request a pulse from any head-end, intermediate server or STB. For example if a periodically monitored ‘pulse’ related to processor activity stops, the intermediate storage place may be interrogated by an analysis entity that checks the status of the intermediate storage facility. The analysis entity could be a head-end facility or other network node or may be surviving components of an STB. For example, components of an STB can still have access to the STB processor kernel, even if an STB hard drive fails and information related to failed components may be pushed from the STB as long as communications from the STB are still viable.

In one aspect, when any component of an individual STB fails or a near failure condition is indicated, a conditional message including an indicator datum such as an error code or status log may be pushed to the network. Upon complete power cut-off to an STB, a battery back-up or capacitor may be capable of supplying enough power to supply power to the STB long enough to push a conditional message containing the log file that has been resident in memory (RAM or equivalent) over the network to a network node.

When an STB fails without an opportunity to push out a last conditional message data or signal, the periodically or continuously updated STB log file (performance history data) may still reside at an intermediate location (non-volatile RAM) on the STB on an intermediate storage such as an intermediate server or SHO (CO, IO, VHO) in the IPTV network. If the power is still available to the STB processor operating system, non-volatile RAM may still be accessible since the kernel is still available when using an embedded operating system (OS). CPE component drivers may be available for various interfaces. For example, error logs or status messages may still be sent via a wireless interface or through an Ethernet cable interface since the operating system drivers may still be running. The initiation of error log communication to a network server or head-end facility may be triggered upon the failure of any component within a device or a failure of a processor status parameter like a processor pulse. If a device component failure includes a power interruption, a temporary power backup system (e.g., a battery or a capacitor) enables a device operating system to push a conditional message containing the error log file.

Besides STB component failures, other conditional triggers that initiate conditional messages pushing STB conditional message data containing an error log communication to a network server or head-end facility include whether incoming or outgoing signal strength or reliability is determined to be above or below a predetermined threshold. Conditional message data may also be pushed to STB or intermediate server storage on a timed basis, for example, once per hour or once per day. Other triggers or conditions may be whether Quality of Service parameters (indicator datum) are determined to be above or below predetermined thresholds.

Following a prior node or head end failure, after communications to customers are restored and the head end or node is restored, and operationally up and running, the node or head end sends conditional message data to customers' STBs that the node or head-end is again up and running. These options include e-mail, telephone calls, and VoIP and pager communications. These options also include using a communication channel available to customers that is dedicated to system status information. In one aspect the head-end or intermediate server (CO, IO, and SHO) notifies downstream CPE STBs of current network and head end conditions as well as predictions as to when network services will resume.

When an STB is experiencing difficulties, problem status notification in conditional message data may be pushed to a network node over an alternate communication route or back-channel to the network communication route used during normal operations between the STB and the IPTV head end in the IPTV network. For example, a coaxial cable may have a signaling channel to use for access to and from the STB. Alternatively a satellite uplink or a PSTN or VoIP phone line link backup may provide for redundant or supplementary pushed communications of conditional messages containing error log files. For devices equipped with a wireless gateway or interface, such as a remote gateway (RG), the wireless RG allows for storing conditional message data including but not limited to an error log and pushing conditional message data. The wireless RG pushes the conditional message data to a service provider's gateway or network node.

Other CPE components, including or related to televisions, telephones and power facilities may also offer alternative routes for pushing conditional messages containing error log files to network nodes. Communication routes associated with other household appliances may offer alternate paths for status reporting. A communications data-link may be set up over a wireless, wireline, Ethernet, or other IP link. Wireless protocols between CPE and associated components include but are not limited to Broadband Wireless Access equipment including General Packet Radio Service (GPRS), Universal Mobile Telecommunications System (UMST), WiMax, Zigbee, or any wireless peer-to-peer connections.

The conditional messages pushed to the information consumer may be displayed on the television monitor, broadcast (or multicast) to a selected number or group of channels, or only the channels affected. STBs may be selected as sets based on geographic region, targeted advertising group or by IPTV network node from which an STB set receives data directly. For example if an STB hard drive component on a CPE has failed, conditional message data to a consumer's STB may be pushed from a network server indicating that the problem has been diagnosed. The message may be brought down granularly for example, if it is determined that a hard drive is no longer functioning, so that the pushed conditional message transmission may be communicated on an alternate channel such as a control channel. Additional pushed communications may occur as recorded audio messages on the subscriber's telephone with an optional menu interface to an automatic voice response system. If the STB is ‘off’ then when STB is turned on again and service is resumed, an e-mail or telephone notification can be pushed to the user/customer or to a user associated remote gateway.

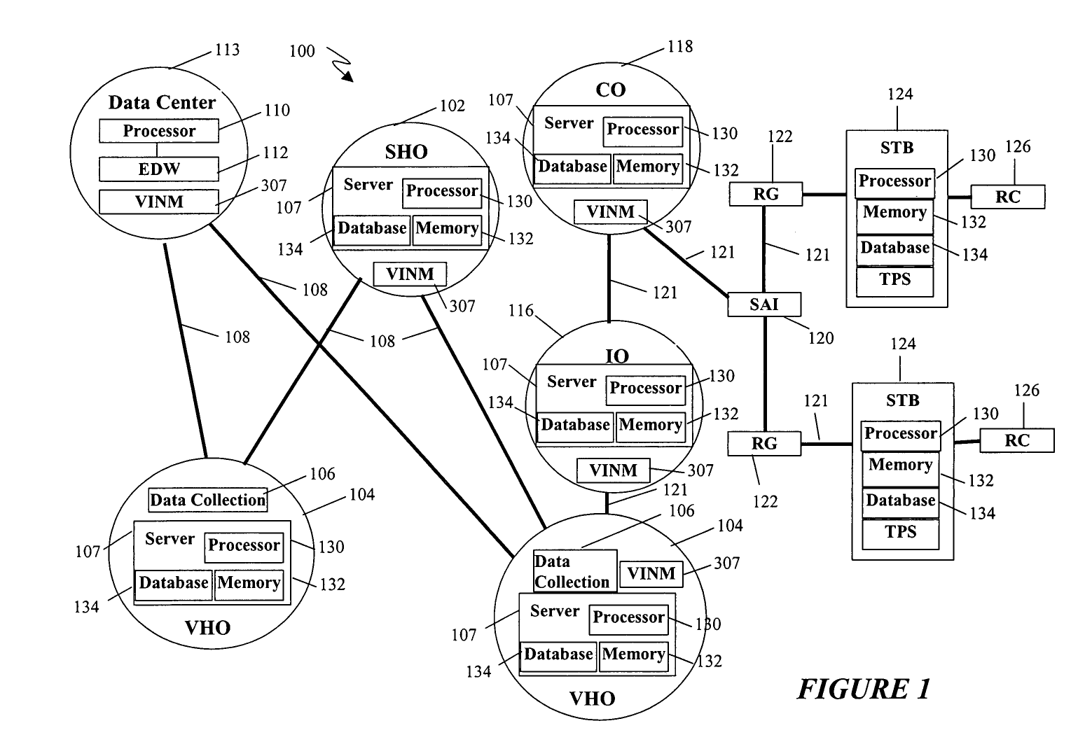

Turning now to FIG. 1, FIG. 1 is a schematic diagram depicting an IPTV network employing an SHO and multiple VHOs in multiple geographic regions in accordance with an embodiment of the present invention. As shown in FIG. 1, in an illustrative embodiment the communication network 100 includes but is not limited to: a super hub office (SHO) 102, or head-end, for acquisition and encoding of video content; a video hub office (VHO) 104, also a head-end, in each demographic market area (DMA); Intermediate offices (IO) 116 and central offices (CO) 118 locations in each metropolitan area; the access network (SAI) between the central offices and multiple or single dwelling units; and the in-home network with gateway, for example, residential gateway (RG) 122. The RG is an example only as any gateway or access point to the IPTV network may be used. The SHO, VHO, IO and CO may be located in separate geographic regions (nation, region, state, metropolitan, city and service area interface (SAI)) to communicate to subscriber STBs over high speed digital communication lines 108.

A server 114 placed at the SHO 102 acquires and redistributes content to the VHOs 104 which may be spread across a large geographic region such as a country, such as the United States, England or France. The SHO may be provided in a geographically central location for acquisition of national-level broadcast TV (or linear) programming. Initially, the SHO can also be the central point of on-demand content acquisition and insertion of content into the IPTV network. Linear programming can be received at the SHO 102 via satellite and processed for delivery to the VHOs 104. On demand content is received from various sources and processed for code/decode and bit-rate requirements for the IPTV network for transmission to the VHOs over high speed communication links 108.

The VHOs 104 can receive national content from the SHO 102 video server 114. The VHOs are the video redistribution points within each designated market area (DMA) or geographic region. Application systems, regional subscriber database systems, video on demand (VOD) servers, and fast channel-change servers can be located in the VHO. In the present example of the invention, at least one IPTV data collection processor 106 is placed at each VHO. The IPTV data collection processor 106 includes memory and input/output. Thus, IPTV conditional messages including conditional message data can be collected at the IPTV data collection processor 106 from all subscribers' STBs associated with a particular VHO and sent to an electronic data warehouse (EDW) 112 for analysis by a VINM 307. A single server 107 can be placed at the SHO. Server 107 includes a processor, memory and database. Content and data including conditional message data from SHO server 114 is redistributed to the VHOs 104 toward the subscriber via the intermediate offices (IOs) 116 and the central offices (COs) 118. The COs are connected to the IOs to further distribute video content toward the subscribers. As the IPTV network state is reconfigured, additional proposed servers 107 can be placed in geographic regions containing the SHO, VHO, IO and CO in the IPTV network. Each server 107 includes but is not limited to a processor 130 coupled to memory 132 and database 134 in memory 132.

Data reaches the subscribers residential gateway (RG) 122 at least partially via either fiber to the node (FTTN) or fiber to the premises (FTTP). FTTN equipment, located at a serving area interface (SAI) 120, can be connected to the CO. FTTN equipment may also be located in the CO. Toward the subscriber household, a network interface device (NID) and RG 122 with a built-in VDSL modem or optical network termination (ONT) can be included in the customer premise equipment (CPE). In both cases the RG is connected to the rest of the home STBs 124 via an internal network such as an Ethernet. Each STB has an associated remote control (RC) 126 which provides data entry to the STB to control the IPTV selections from the IPTV system. An STB may include but is not limited to a processor, memory, database and temporary power supply (TPS). A TPS may be a battery or a capacitor.

STB conditional messages contain conditional message data, the data including an indicator message datum such as an error code or log data and subscriber activity data including but not limited to IPTV channel selection, control inputs and data entry are pushed from each STB in a household to the IPTV network or STB memory. The conditional message data may be collected and pushed from the RG to an IPTV data collection processor 106. An IPTV data collection processor 106 runs in each VHO. The data collection processor 106 may be associated with server 107 and/or the IPTV data collection processor 106 may include a processor with memory and input/output. The conditional message data subscriber activity data can be pushed periodically to an intermediate server where the data can be processed by, for example, an IPTV data collection processor 106 or in real-time from each STB to the electronic data warehouse (EDW) 112. The IPTV data collection processors 106 push the subscriber activity data to the EDW 112 in a secure Data Center 113. The Data Center 113 is an internal location within a secured firewall. EDW 112 may be a commercial database such as provided by Oracle running on a Sun Microsystems processor. Other processors and database systems are suitable for use as well.

The EDW comprises a processor and data storage medium that provides mass storage and business rules for analysis of the conditional message data including STB status data, error logs and subscriber activity data. A processor, for example, data collection application processor 110 associated with the EDW or any server runs in a processor 110 at the Data Center. Processor 110 applies the business rules stored in the EDW to analyze conditional message data stored in the EDW. The conditional message data is pushed from each VHO to the EDW. The subscriber activity data from each STB to a VHO is pushed periodically or in real time and relayed to the EDW. Real time data pushing through conditional messages enables real time data analysis for iterative analysis of the IPTV network and dynamic management of content and advertising distribution at the VHO. Targeted advertising campaigns target desired subscribers to received targeted advertisements by selecting a hit list of STBs to receive the targeted advertisements. STBs that have failed or are turned off as indicated by conditional message data can removed from the hit list.

By analyzing conditional message data stored at the EDW, STB or in an intermediate server, failed, marginally operative STBs or STBs that are turned off can be eliminated from targeted advertising campaigns hit list of STBs, saving targeted advertising dollars based on a cost per thousand STBs targeted per advertisement. The advertising is sent only to fully operational STBs remaining on the hit list.

The STB 124 may forward the subscriber activity data to the RG which in turn sends the conditional message data to IPTV data collection processor 106 via a communication path 121 between the VHO and the associated RG. Conditional message data including but not limited to substantially all STB error log data, STB status data and consumer activity data including but not limited to remote control activity may be pushed and recorded as conditional message data at the IPTV data collection processors 106 and sent to the EDW 112. The STB can contain a single microprocessor and memory, or may be implemented as multiple microprocessors and memories located at a single location or at several locations. The STB may contain memory including a hard drive and random access memory. A downstream signal from the IPTV network to a display device includes but is not limited to content for display on the display device, and an upstream signal from the display device to the IPTV network instance (via the remote control) includes conditional message data subscriber activity data comprising channel selections and any other input from the RC.

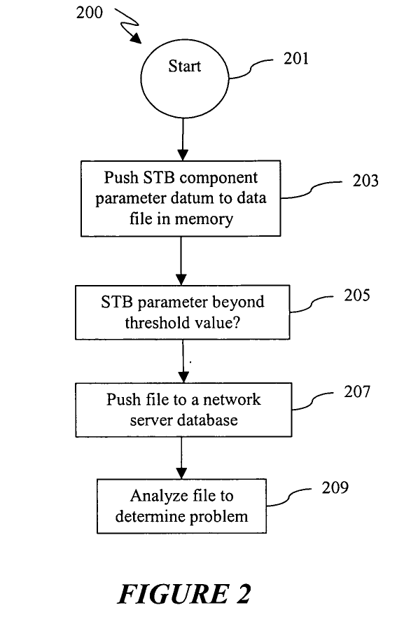

Turning now to FIG. 2, FIG. 2 is an illustrative embodiment of a process flow of conditional message data and indicator datum including but not limited to error log data or status information data from an STB to a Head-End (for from a network node to an STB) or other intermediate IPTV node or information storage and analysis facility. In one embodiment a process begins 201 as parameter data within an STB are monitored. Parameter data related to STB components and functions of an STB is recorded in memory as a data file 203. The STB 124 includes a processor 130 for manipulating the STB parameter data and a memory for recording the STB parameter data. If an STB parameter datum is beyond a predetermined threshold value 205, the data file or some portion of the data file may be designated as an error file and sent to a network server database 134 in a conditional message. The network server database 134 may reside or be mirrored on many of the tiered network facilities including a CO 118, an IO 116, a VHO 104, an SHO 102 or any other head-end facility, or in a data center 113. A VINM 307 may reside in any of the network servers and associated database. The VINM performs correlation and analysis of conditional message data pushed from a plurality of set-top boxes. VINM may operate on any network server 107 of any of the tiered network facilities. Software agents or technical personnel analyze and determine responses to network and STB problems, and may proactively contact or send conditional message data to STBs that may be affected by the problems. The STBs receiving the conditional message data may be grouped by geographic region or by IPTV network node from which the STBs receive their video data.

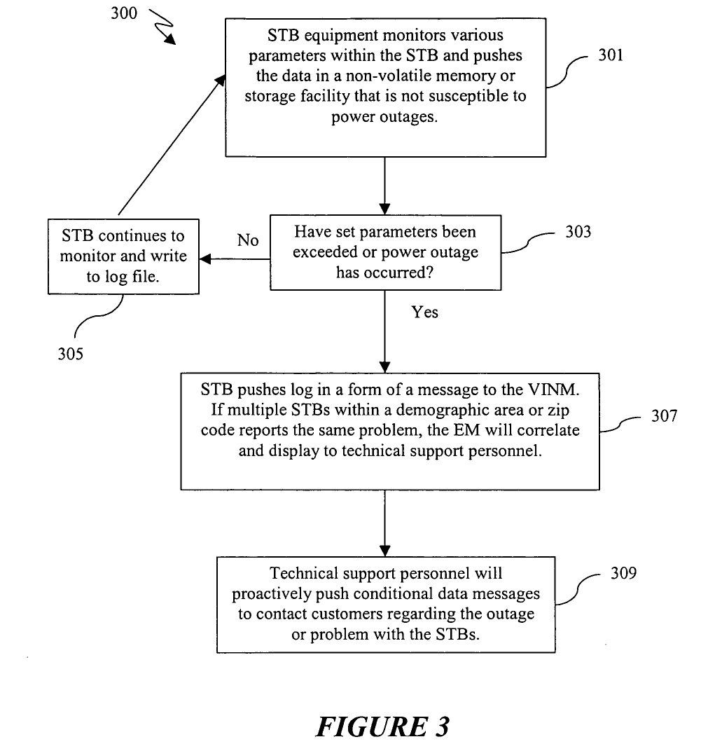

Turning now to FIG. 3, FIG. 3 is an illustrative embodiment of a process flow of conditional message data and indicator datum including but not limited to, error log or status information from an STB to a Head-End or other information storage and analysis facility. An STB processor monitors various parameters within the STB and pushes the information as conditional message data into a non-volatile memory or storage facility that is not susceptible to power outages 301. Next, a determination is made whether a set of STB parameters has been exceeded or an STB power outage has occurred 303. If these conditions are not met, the STB continues to monitor and push data to a log file 305. If the set parameters have been exceeded or a power outage has occurred, the STB pushes log data in a form of a conditional message data to a network server 107 (e.g., a CO 118, an IO 116, a VHO 104, an SHO 102 or any other head-end facility, or in a Data Center 113) which server may include a VINM 307. If multiple STBs (a set of STBs) within a demographic area or zip code report the same or a similar problem, the VINM 307 will correlate multiple STBs (set) data and display correlated data to network or service provider technical support personnel. At this point, EDW or VINM business rules and software agents or technical support software agents proactively push conditional messages to contact customers 309 regarding the outage or problem associated with the set of STB(s).

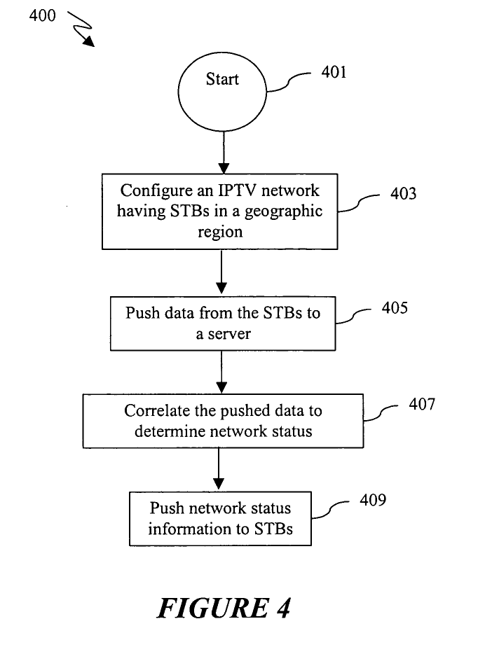

Turning now to FIG. 4, FIG. 4 is an illustrative embodiment of a process flow of conditional message data including but not limited to error log data and/or STB state information data and STB parameter data related to an STB. In one embodiment a process begins 401 as an IPTV network is configured for monitoring having a multiplicity of STBs in a geographic region 403. STB associated state data are sent from the multiplicity of STBs to a network server 405. The pushed STB associated data are correlated 407 to determine network status information related the geographic region. Network status information data is pushed to a set selected from the multiplicity of STBs 409.

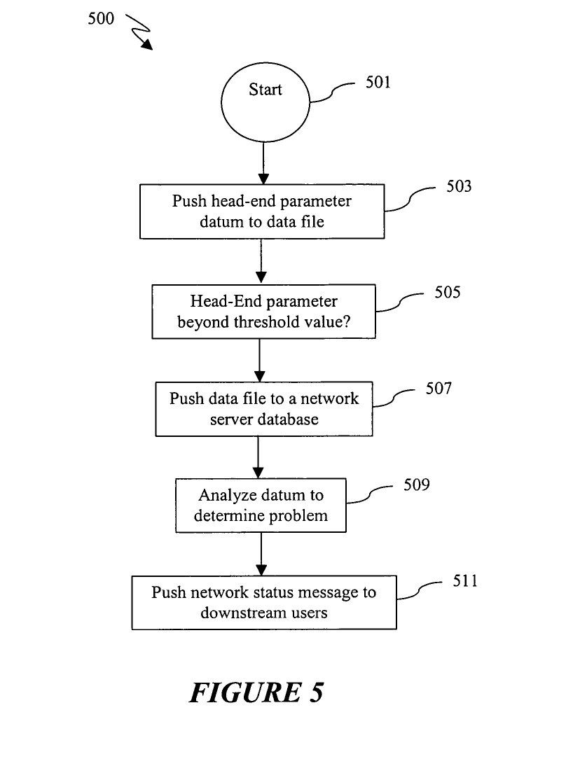

Turning now to FIG. 5, FIG. 5 is an illustrative embodiment of a process flow of conditional message data including but not limited to error log or status information from an IPTV node such as a Head-End or other information storage and analysis facility to an STB. In a particular embodiment a process begins 501 as parameters within a head-end facility (e.g., a CO 118, an IO 116, a VHO 104, an SHO 102 or any other head-end facility, or in a Data Center 113) are monitored. The head-end facility may include a server 107. Parameters and data related to components and functions of the head-end may be pushed to memory as a data file 503. The head-end includes a processor for manipulating the parameter data and a memory and database for recording the data. If a parameter datum (indicator datum) is beyond a predetermined threshold value 505, the data file or some portion of the data file may be designated an error file including the indicator datum and pushed to another network server database 507 or head-end facility. The network server database may reside or be mirrored on many of the tiered network facilities including a CO 118, an IO 116, a VHO 104, an SHO 102 or any other head-end facility, or in a data center 113. The VINM 307 may reside in any of the network server facilities and enables the correlation and analysis of conditional message data received from a plurality of STBs or from the SHO. The VINM may operate on any network server 107 of any of the tiered network facilities. Software agents or technical personnel may be available to analyze and determine responses to problems 509, and may proactively contact or send information data to STBs 511 that may be affected by head-service status changes.

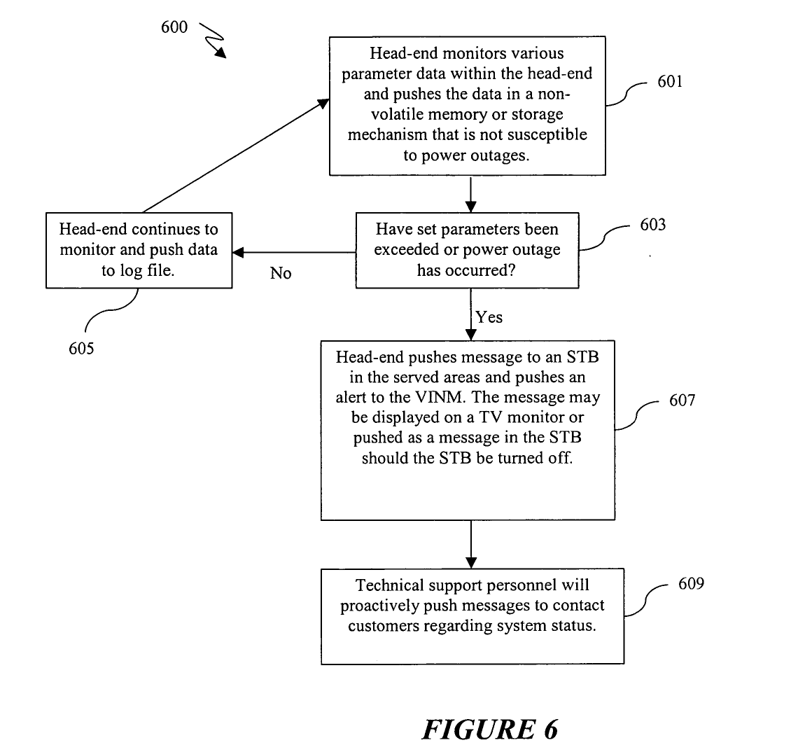

Turning now to FIG. 6, FIG. 6 is an illustrative embodiment of a process flow of conditional message data including but not limited to error log data or status information data pushed in conditional messages from a Head-End (SHO) or other information storage and analysis facility to an STB. A head-end monitors various parameters within the head-end and stores the information in a non-volatile memory or storage mechanism that is not susceptible to power outages 601. Next, a determination is made whether a set of parameters has been exceeded or a power outage has occurred 603. If these parameters have not been exceeded, the head-end continues to monitor its components and push data to a log file 605. If the parameters have been exceeded, the head-end may send a conditional message to an STB in the served areas and push a conditional message containing conditional message data and/or an indicator datum as an alert message 607 to the VINM 307. The pushed message to the VINM may be displayed on a TV monitor or stored as a message in the STB should the STB be turned off. Technical support software agents proactively push conditional messages to STBs to contact customers or send status information to STBs regarding system status 609.

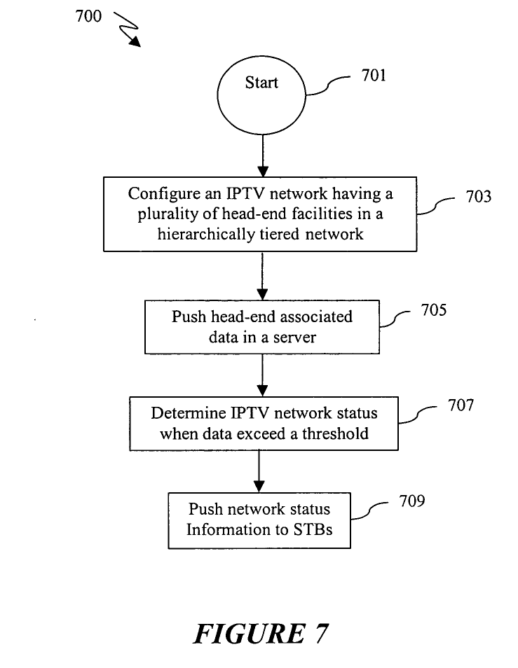

Turning now to FIG. 7, FIG. 7 is an illustrative embodiment of a process flow of conditional message data including but not limited to error log data or status information data related to a head-end facility (e.g., SHO, VHO, etc.). In a particular embodiment a process begins 701 as a network having a plurality of head-end facilities (e.g., a CO 118, an IO 116, a VHO 104, an SHO 102 or any other head-end facility, or in a Data Center 113) is configured 703. Data associated with one or more head-end facilities are pushed in a conditional message to a server 705. An IPTV network status is determined when the associated data exceed a threshold 707. Network status information is sent to STBs 709.

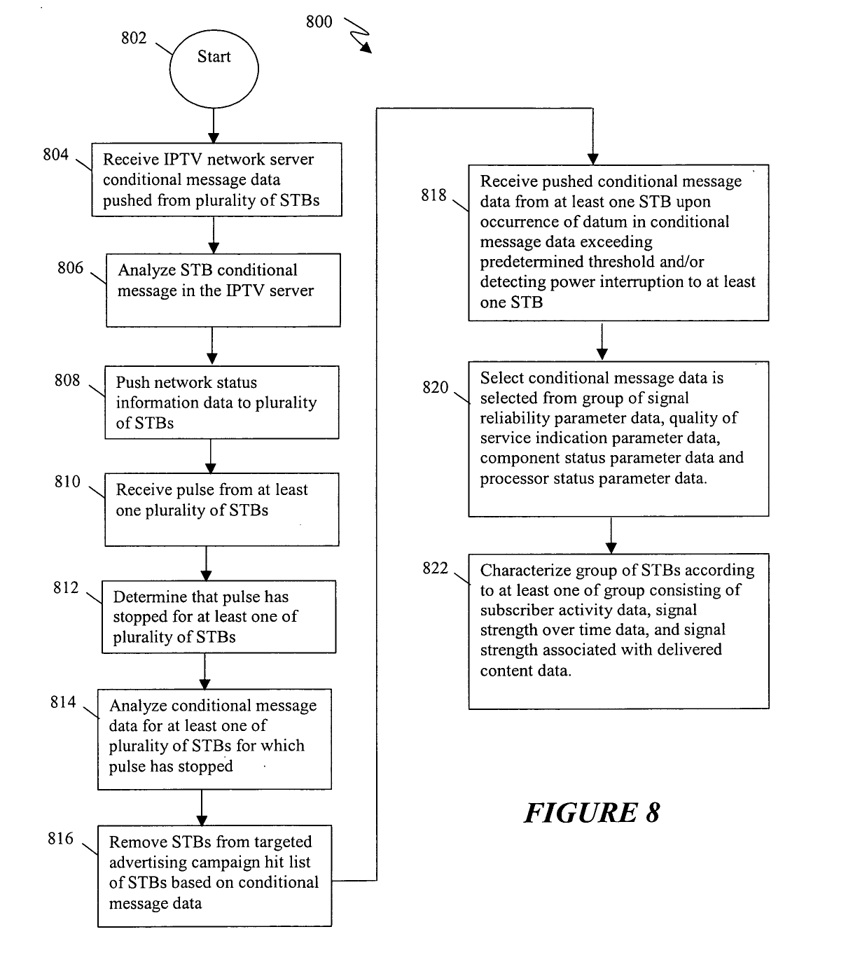

Turning now to FIG. 8, FIG. 8 is a flow chart for an a particular illustrative embodiment for monitoring an IPTV network. Block 802 starts the monitoring by receiving conditional message data pushed from a multiplicity of STBs at 804. STB conditional messages are analyzed at block 806. The network status information data is pushed to the multiplicity or set selected from the multiplicity of STBs at block 808. A pulse is received from a multiplicity of STBs at block 810. A determination is made that pulse has stopped for at least one of the multiplicities of STBs at block 812. The conditional message data is analyzed for at least one of the multiplicity of STBs for which the pulse has stopped at 814. STBs are removed from a group targeted advertising campaign based on the conditional message data at block 816. Pushed conditional message data is received from at least one of the STBs upon occurrence of an indicator datum in conditional message data exceeding a predetermined threshold or detecting a power interruption to at least one of plurality of STBs at block 818. The conditional message data is selected from group of signal reliability parameter data, quality of service indication parameter data and processor status parameter date at 820. Sets of STBs are characterized according to at least one of group consisting of subscriber activity data, signal strength over time data, and signal strength associated with delivered content data.

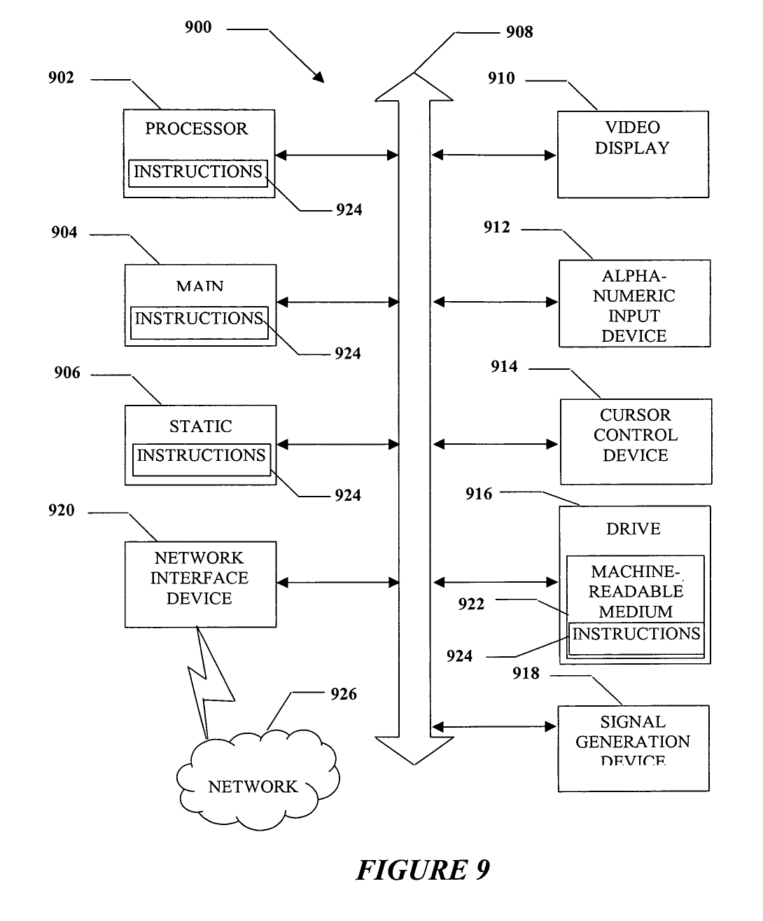

Turning now to FIG. 9, FIG. 9 is a diagrammatic representation of a machine in the form of a computer system 900 within which a set of instructions, when executed, may cause the machine to perform any of one or more of the methodologies discussed herein. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment. The machine may comprise a server computer, a client user computer, a personal computer (PC), a tablet PC, a set-top box (STB), a Personal Digital Assistant (PDA), a cellular telephone, a mobile device, a palmtop computer, a laptop computer, a desktop computer, a personal digital assistant, a communications device, a wireless telephone, a land-line telephone, a control system, a camera, a scanner, a facsimile machine, a printer, a pager, a personal trusted device, a web appliance, a network router, switch or bridge, or any machine capable of executing a set of instructions (sequential or otherwise) that specify actions to be taken by that machine. It will be understood that a device of the illustrative includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 900 may include a processor 902 (e.g., a central processing unit (CPU), a graphics processing unit (GPU), or both), a main memory 904 and a static memory 906, which communicate with each other via a bus 908. The computer system 900 may further include a video display unit 910 (e.g., liquid crystals display (LCD), a flat panel, a solid state display, or a cathode ray tube (CRT)). The computer system 900 may include an input device 912 (e.g., a keyboard), a cursor control device 914 (e.g., a mouse), a disk drive unit 916, a signal generation device 918 (e.g., a speaker or remote control) and a network interface device 920.

The disk drive unit 916 may include a machine-readable medium 922 on which is stored one or more sets of instructions (e.g., software 924) embodying any one or more of the methodologies or functions described herein, including those methods illustrated in herein above. The instructions 924 may also reside, completely or at least partially, within the main memory 904, the static memory 906, and/or within the processor 902 during execution thereof by the computer system 900. The main memory 904 and the processor 902 also may constitute machine-readable media. Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the illustrative embodiment, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The illustrative embodiment contemplates a machine readable medium containing instructions 924, or that which receives and executes instructions 924 from a propagated signal so that a device connected to a network environment 926 can send or receive voice, video or data, and to communicate over the network 926 using the instructions 924. The instructions 924 may further be transmitted or received over a network 926 via the network interface device 920.

While the machine-readable medium 922 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the illustrative embodiment. The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the illustrative embodiment is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the illustrative embodiment is not limited to such standards and protocols. Each of the standards for Internet and other packet switched network transmission (e.g., TCP/IP, UDP/IP, HTML, and HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “illustrative embodiment” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

Although the illustrative embodiment has been described with reference to several illustrative embodiments, it is understood that the words that have been used are words of description and illustration, rather than words of limitation. Changes may be made within the purview of the appended claims, as presently stated and as amended, without departing from the scope and spirit of the illustrative embodiment in its aspects. Although the illustrative embodiment has been described with reference to particular means, materials and embodiments, the invention is not intended to be limited to the particulars disclosed; rather, the invention extends to all functionally equivalent structures, methods, and uses such as are within the scope of the appended claims.

In accordance with various embodiments of the present illustrative embodiment, the methods described herein are intended for operation as software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

1. A method for monitoring a plurality of set top boxes (STBs) in an internet protocol television (IPTV) network comprising:
receiving in an IPTV network server conditional message data pushed from a plurality of set top boxes (STBs);
analyzing in the IPTV server, the STB conditional message data to determine network status information data related to a set of STBs selected from the plurality of STBs; and
pushing conditional message data to the set of STBs.

2. The method of claim 1 further comprising:
receiving a pulse from at least one of the plurality of STBs;
determining that the pulse has stopped for the at least one of the plurality of STBs; and
analyzing conditional message data for the at least one of the plurality of STBs for which the pulse has stopped.

3. The method of claim 1 wherein the set of STBs is one selected from the group consisting of a geographic set, targeted advertising set, and network node related set.

4. The method of claim 3 further comprising:
removing STBs from a targeted advertising campaign hit list of STBs based on the conditional message data.

5. The method of claim 1, wherein:
the pushed conditional message data from at least one of the plurality of STBs is received in the IPTV network server upon an occurrence selected from the group consisting of detecting an indicator datum in the conditional message data exceeding a predetermined threshold and detecting a power interruption to at least one of the plurality of STBs.

6. The method of claim 5 wherein the conditional message data is selected from the group consisting of signal reliability parameter data, quality of service indication parameter data, component status parameter data, and processor status parameter data.

7. The method of claim 1 further comprising:
characterizing the set of STBs according to at least one of the group consisting of subscriber activity data, signal strength over time data and signal strength associated with delivered content data.

8. A method for monitoring an IPTV network data from an IPTV head end network server, comprising:
pushing, to an IPTV network server database, conditional message data in a conditional message;
determining an IPTV network status when a parameter of the conditional message data exceeds a predetermined threshold; and
pushing conditional message data indicating IPTV network status information data to a set of STBs.

9. The method of claim 8 wherein the set of STBs is selected from the group consisting of a geographic set, targeted advertising set, and network node related set.

10. The method of claim 8 wherein the conditional message data is selected from the group consisting of signal reliability parameter data, quality of service indication parameter data, component status parameter data, and processor status parameter data.

11. The method of claim 8 further comprising:
pushing conditional message data to the set of STBs when the IPTV network is determined to function below a predetermined threshold.

12. A set-top box (STB) in an IPTV network comprising:
a STB processor coupled to a memory;
a computer program embedded in the memory, the computer program including instructions to push conditional message data to a log file when an indicator datum in the conditional message data exceeds a predetermined threshold and instructions to push the conditional message datum to an IPTV network server; and
an interface in data communication with the IPTV network server.

13. The set-top box (STB) of claim 12 wherein the conditional message data is selected from the group consisting of signal reliability parameter data, quality of service parameter data, component status parameter data and processor status parameter data.

14. The set-top box (STB) of claim 12 wherein the memory is associated with a network server database that is selected from the group consisting of a subscriber activity log database, an STB component status database, and a video infrastructure element manager database.

15. The set-top box (STB) of claim 12, further comprising:
a temporary power source that provides power to the STB when the STB loses power, wherein the temporary power source is selected from the group consisting of a capacitor and a battery.

16. A system for monitoring an IPTV network comprising:
an IPTV head-end server processor coupled to a memory in the IPTV server;
a computer program embedded in the memory, the computer program including instructions to acquire conditional message data and instructions to push the conditional message data to memory when an indicator datum in the conditional message data exceeds a predetermined threshold; and
an interface in data communication with a network server database.

17. The system of claim 16 further comprising:
a pulse interface in data communication with an intermediate server in the IPTV network.

18. A computer readable medium having a computer program for monitoring an internet protocol television (IPTV) network embedded therein, the computer program comprising:
instructions to receive in an IPTV network server conditional message data pushed from a plurality of set top boxes (STBs);
instructions to analyze in the IPTV server, the STB conditional message data to determine network status information data related to a set of STBs selected from the plurality of STBs; and
instructions to push network status information data to the set of STBs.

19. The medium of claim 18 further comprising:
instructions to receive a pulse from at least one of the plurality of STBs;
instructions to determine that the pulse has stopped for the at least one of the plurality of STBs; and
instructions to analyze conditional message data for the at least one of the plurality of STBs for which the pulse has stopped.

21. The medium of claim 18 wherein the set of STBs is selected from the group consisting of a geographic set, targeted advertising set, and network node related set.

22. The medium of claim 21 further comprising:
instructions to remove STBs from a targeted advertising campaign hit list of STBs based on the conditional message data.

23. The medium of claim 18, wherein the pushed conditional message data from at least one of the plurality of STBs is received in the IPTV network server upon the occurrence selected from the set consisting of an indicator datum in the conditional message data exceeding a predetermined threshold and detecting a power interruption to at least one of the plurality of STBs.

24. The medium of claim 18 wherein the conditional message data is selected from the group consisting of signal reliability parameter data, quality of service indication parameter data, component status parameter data, and processor status parameter data.

25. The medium of claim 18 further comprising:
instructions to characterize the set of STBs according to at least one of the group consisting of subscriber activity data, signal strength over time data and signal strength associated with delivered content data.

26. A computer readable medium having a computer program for monitoring an internet protocol television (IPTV) network embedded therein, the computer program comprising:
instructions to push, to an IPTV network server database, conditional message data in a conditional message;
instructions to determine an IPTV network status when an indicator datum in the conditional message data exceeds a predetermined threshold; and
instructions to push conditional message data including the indicator datum indicating IPTV network status information data to a set of STBs selected from the plurality of STBs.

27. The medium of claim 26 wherein the set of STBs is selected from the group consisting of a geographic set, targeted advertising set, and network node related set.
